(19) United States
(12) Patent Application Publication
(10) Pub. No.: US 2011/0106648 A1
(43) Pub. Date: May 5, 2011

(54) REVERSE AUCTION METHOD

(76) Inventor: Ki-Ju Kim, Gwang-ju (KR)

(21) Appl. No.: 13/001,594

(22) PCT Filed: Jun. 25, 2009
(86) PCT No.: PCT/KR2009/003435

§ 371 Date: Dec. 27, 2010

(30) Foreign Application Priority Data
Jun. 25, 2008 (KR) 10-2008-0060018
Apr. 8, 2009 (KR) 10-2009-0030121
Jun. 25, 2009 (KR) 10-2009-0056806
Jun. 25, 2009 (KR) 10-2009-0056824
Jun. 25, 2009 (KR) 10-2009-0056828

(51) Int. Cl. G06Q 30/00

(52) U.S. Cl. 705/26.3

(57) ABSTRACT

The present invention relate to a reverse auction method in an electronic commerce system. The present invention provides a reverse auction method using an electronic commerce system in which a reverse auction server, a plurality of purchase apply terminals at the purchaser side, and a plurality of sales apply terminals at the seller side communicate with one another through a communication network such as the Internet. The reverse auction method includes: a first step of transmitting purchase apply information containing a purchase maximum price and a purchase apply quantity inputted by each purchaser for the same product and storing the purchase apply information in the reverse auction server; a second step of allowing the reverse auction server to provide a connected seller or purchaser with a purchase apply status containing a purchase apply quantity for each purchase maximum price or an accumulated purchase apply quantity for each accumulated purchase maximum price accumulated to the level equal to or higher than each purchase maximum price; a third step of transmitting bidding information containing a desired sales price inputted after review of the purchase apply status by each seller and storing the bidding information in the reverse auction server; a fourth step of allowing the reverse auction server to provide or notify, after the completion of bidding, the result of bidding in which a seller who has made a bid at the lowest desired sales price is determined as a winning bidder, the relevant desired sales price is determined as a contract price, i.e., a sales price, the purchase apply quantities of all purchase maximum prices equal to or higher than the contract price are intensively bid to the winner, and sellers other than the winning bidder are left out of the bidding; and a fifth step of allowing the reverse auction server to provide or notify the result of a deal in which all purchasers who have applied at the purchase maximum price equal to or higher than the contract price are determined as purchasers entitled to make a purchase, all purchasers who have applied with the purchase maximum price lower than the contract price are left out of the bidding, and the contract price is contained.

Accordingly, through a reverse auction performed just once, a plurality of successful purchasers who have inputted different purchase maximum prices for the same product may purchase the product at the same lowest price, and applications for purchase made by a plurality of dropout purchasers are automatically cancelled, thereby satisfying all purchases (applicants) including successful purchasers (applicants) and dropout purchasers (applicants), and enabling the winning sellers to sell a large quantity of products on a small profit and quick return basis, thus providing the largest profits to both the purchasers and the sellers.

### BACKGROUND OF THE INVENTION

1. Field of the Invention

Exemplary embodiments of the present invention relate to a reverse auction method of electronic commerce, and more particularly, to a reverse auction method, in which a plurality of purchasers can purchase a product at the same lowest price through the reverse auction performed just once, and sellers can sell a large quantity of products at a time.

2. Description of Related Art

NMI In general, in order to purchase a product at a low price through electronic commerce, a purchaser should search for web stores selling the product at a further lower price or a seller selling the product at the lowest price within a specific web store and purchase the product, gather a plurality other purchasers and jointly purchase the product in bulk through a group purchasing method, participate in and win a bid to purchase the product through an auction method, or compare offers receive from a plurality of sellers and purchase the product through a reverse auction method.

Among these methods, the group purchasing method is aiming at the effect of price reduction by purchasing a large quantity of products at a time. However, it is difficult to gather a large number of purchasers, and although a sufficiently large number of purchasers are gathered, sellers previously determine the price of the product by the quantity of purchase in many cases, and thus a lowest price is not guaranteed.

In the auction method, a plurality of purchasers competes for a product of a seller. From the viewpoint of a purchaser, it is difficult to purchase a desired product at a right time since the chance of winning a bid is extremely low. In addition, the purchaser should offer a high purchase price in order to win the bid since it is difficult to win the bid. Therefore, although the purchaser wins the bid, he or she is not satisfied with the contract price as a result, and it is inconvenient to frequently participate in a bid. In addition, from the viewpoint of a seller, since an auction is set for a small quantity of products, it is troublesome and does not make a sufficient profit as a result.

In the reverse auction method, a plurality of sellers competes for a purchaser. From the viewpoint of the purchaser, although the purchaser received offers from a large number of sellers and purchases a product from a seller offering the lowest sale price, it is not guaranteed that a sales price is determined to be lower than the prices offered by general open-markets such as Interpark and Gmarket.

Since sellers can be dropped out, but purchasers never be dropped out in a conventional reverse auction method, even a purchaser dissatisfied with the contract price should purchase the product after the auction is over, and thus it is difficult to obtain information on the number of purchasers who will actually purchase the product among the purchasers succeeded in the bid (practically, all the purchase applicants). Although a seller wins the bid at an extremely low price calculated on a small profit and quick return basis, if a lot of purchasers cancel the purchase, profit could be much less than expected, or the seller can make a loss in some cases. Therefore, the seller cannot make a bid at an extremely low price, and thus the contract price will be raised as a result.

From the viewpoint of a seller, since reverse auctions are not actively used and a lot of purchase applicants are not gathered, it is troublesome to frequently participate in an auction for a small quantity of products, and it does not make a sufficient profit.

That is, since either purchasers or sellers compete with one another accepting his or her loss in an auction or reverse auction method, the methods cannot generate a profit for both the purchasers and sellers.

On the other hand, a way of lowering a sales price to the maximum in online or offline markets is trading products in bulk by increasing the quantity of product traded at a time. Since sellers can greatly save distribution cost and promptly collect invested amounts, they can sell the product at a price lowered to the maximum, and purchasers can purchase the product at a price lowered as much. Therefore, it can make a profit to both the sellers and purchasers.

From the viewpoint of a purchaser, since it cannot be guaranteed that a large number of purchasers are gathered by a desired time in the group purchasing method, and the number of purchasers actually gathered is as small as only 3 or 4, the effect of lowering purchase price cannot be achieved as much as tried. From the viewpoint of a seller, since the “small profit and quick return” strategy does not generate a sufficient profit with only 3 or 4 purchasers, a conventional group purchasing method cannot make a sufficient profit to both sellers and purchasers, and it is difficult to widely use the method for general products.

On the other hand, since decision-making is granted to purchasers corresponding to customers in commercial transactions and inconvenience of bidding is imposed upon sellers, not customers, the reverse auction system is an attractive method that can invite a lot of purchasers fundamentally.

However, the reverse auction method is restrictively used online only for some service products that cannot be standardized, such as photographing services, web site rendering services, and the like, and it is not actively used for general products at all. Considering the reasons from the viewpoint of a purchaser, the purchaser feels uneasy on thinking that a lot of sellers participating in the auction will be suffered if the purchaser cancels purchase. Every purchase applicant automatically wins a bid (automatically succeeds in the bid) as a purchaser entitled (determined) to make a purchase although the purchaser is not satisfied with the contract price, and even in a prepayment method where payment is made before the contract price is determined (before purchasers entitled to make a purchase are determined), a purchaser dissatisfied with the contract price should visit the web site one more time in order to cancel the purchase (it seems that a reverse auction method adopting a prepayment method does not exist until present).

In a post-payment method where payment is made after the contract price is determined (after purchasers entitled to make a purchase are determined), a purchaser should inconveniently visit the web site one more time in order to make a payment to fulfill the purchase.

From the viewpoint of a seller, since reverse auctions are not actively used yet, the number of purchase applicants is small, and the quantity of product to be sold through a reverse auction is very small. Since every purchase applicant automatically wins a bid (automatically succeeds in the bid) as a purchaser entitled (determined) to make a purchase although the purchaser is not satisfied with the contract price, there are a lot of cases where a purchaser dissatisfied with the contract price cancels the purchase. Therefore, since a seller cannot exactly estimate how many products will be sold even for the quantity determined in the auction, the seller cannot but make a bid at a high sale price taking a profit into account. If the seller makes a bid at such a high price, it is difficult to win the bid as much. Furthermore, although the seller wins the bid with difficulty by offering a low sale price calculated on a small profit and quick return basis under the assumption that the purchasers who automatically win (automatically succeed in) the bid will certainly make a purchase, if winning purchasers cancel the purchase at a later time, the seller can make a loss instead, which will be caught in a vicious circle.

Therefore, t is desirable to provide a reverse auction method, in which purchasers are guaranteed to win a bid at a lowest contract price, and sellers are previously informed of exact quantity of product to be sold, so that a bid can be made at a reasonable real lowest price by calculating a profit on a small profit and quick return basis.

### SUMMARY OF THE INVENTION

The present invention has been made to solve the above problems, and it is an object of the present invention to provide a reverse auction method that can generate the best profit for both sellers and purchasers, in which all the purchasers (applicants) including both successful purchasers (applicants) and dropout purchasers (applicants) can be satisfied by adopting various measures of automatically dropping out dissatisfied purchasers (applicants) if a contract price does not meet a purchase maximum price presented by each purchaser (applicant) when the purchaser applies for purchase, automatically canceling purchase apply of the dropout purchasers (applicants), and allowing the successful purchasers (applicants) to purchase a product at the same contract price although the purchasers (applicants) have applied for purchase at different purchase maximum prices, and the sellers can offer a reasonable and real lowest desired sales price since a winning seller can be awarded a contract for a large quantity of products that are almost guaranteed to be sold and sell the products for certain on a small profit and quick return basis, through the reverse auction performed just once.

Describing a conventional reverse auction method in further detail, reverse auction methods of electronic commerce are restrictively applied to trades that are difficult to model, including trade of a product having different purchase conditions for different purchasers such as a moving reverse auction, a web site rendering reverse auction, and the like, i.e., trade of a product that is difficult to model, or the reverse auction methods are applied to trades that have special purchase conditions on purchasing a product in bulk although the product can be modeled (standardized). Trade based on the reverse auction method is not devitalized even in the fields where the reverse auction methods are restrictively applied.

The products that can be modeled are mainly traded in open-market shopping malls trusted by purchasers, such as Interpark (http://www.interpark.com) or Gmarket (http://www.gmarket.co.kr), in which the purchasers select a seller offering the lowest sale price among a plurality of sellers offering different sale prices.

Describing the reasons why the products that can be modeled are not actively traded through conventional reverse auctions, most of conventional reverse auctions trading the products that can be modeled have factors A and B described below.

A. starting bid is considered to be an important factor, and the starting bid is formulated.

Since even a purchaser dissatisfied with the contract price automatically wins (automatically succeeds in) a bid as a purchaser entitled (determined) to make a purchase, i.e., purchasers will never be dropped out, it needs to seriously formulate a starting bid in order to minimize the number of purchasers dissatisfied with the contract price and to minimize sellers' dissatisfaction with an exorbitantly low starting bid.

(Since the starting bid is meaningless at all in the method of the invention, it is not even tried to determine a starting bid. Particularly describing the starting bid, the highest purchase maximum price among the purchase maximum prices presented by purchasers can be the starting bid. In the method of the present invention, since purchasers dissatisfied with the contract price lose the status of a purchaser entitled to make a purchase, the starting bid has no meaning at all.)

B. No one among the purchasers who have applied for purchase will be automatically dropped out after a contract price is determined. (In the method of the invention, some purchasers among the purchasers who have applied for purchase can be automatically dropped out after a contract price is determined (after purchase is determined).)

Generally, a conventional reverse auction for a product that can be modeled is processed as described below.

1. If a web site operator arbitrarily determines a starting bid considering various situations or each purchaser presents a desired purchase price, any one of a maximum value, an average value, and a minimum value of the desired purchase prices presented by the purchasers is determined as a starting bid.

2. Sellers bid a sales price.

3. A seller offering the lowest sale price wins the bid.

4. Purchasers satisfied with the contract price make a payment.

(It is a method where sellers may be dropped out, but purchasers will never be dropped out. In the method of the present invention, purchasers also can be dropped out.)

If a reverse auction is processed in this manner, in a post-payment method where payment is made after a contract price is determined (after purchase is determined), since sellers do not have information on the number of purchasers who will make a payment finally among all the purchase applicants (or, even in a prepayment method where payment is made when a purchaser applies for purchase, sellers do not have information on the number of purchasers who will cancel the purchase after the contract price is determined), or the sellers do not know how many products will be actually sold, i.e., the sellers do not have information on the exact quantity of products to be actually sold, the original spirit of the reverse auction is faded out, and the purchasers make a purchase at a high price although they make a purchase in bulk, and thus the purchasers cannot enjoy the benefit of price reduction of the reverse auction.

Describing the number of visits to the web site, in a post-payment method where payment is made after a contract price is determined (after purchase is determined), a purchaser who actually make a purchase visits the web site twice, i.e., once when the purchaser applies for purchase, and once when the purchaser makes a payment. In a prepayment method where payment is made before the contract price is determined (before the purchase is determined) (mainly, when the purchaser applies for purchase), a purchaser who is not willing to actually make a purchase should visit the web site twice, i.e., once when the purchaser applies for purchase, and once when the purchaser cancels the purchase after the contract price is determined.

At any rate, in either of the prepayment or post-payment method, a purchaser will have the trouble of visiting the web site twice.

In the method of the present invention, if a prepayment method is adopted, a purchaser who will actually make a purchase needs to visit the web site only once before a contract price is determined (mostly when the purchaser applies for purchase).

For example, if a prepayment is made when a purchaser applies for purchase and the amount prepaid when the purchaser applies for purchase is larger than a sales amount reflecting the contract price, a difference of subtracting the sales amount reflecting the contract price from the amount prepaid when the purchaser applies for purchase is refunded, and the products are delivered. If the amount prepaid when the purchaser applies for purchase is smaller than the sales amount reflecting the contract price, it is possible to automatically cancel the purchase apply and refund the total prepaid amount, and thus all the purchase applicants need to visit the web site only once when they apply for purchase.

Any purchase applicant does not need to visit the web site twice.)

In a conventional reverse auction method, whether a prepayment or a post-payment is made before or after the contract price is determined, if penalties (e.g., money, points, or credit) are imposed on the purchasers who cancel the purchase although they win the bid, there will arise a problem.

(Since purchasers who have applied for purchase at a price lower than the contract price also succeed in the bid as a purchaser, such purchasers will complain about the penalties.)

Describing the method of the present invention, when a reverse auction of electronic commerce is processed for products of the same model at the same auction proceeding time with the presence of a plurality of sellers and purchasers, each purchaser presents a maximum price (a purchase maximum price) that can be paid for the product to be purchased, and each seller offers an acceptable desired sales price. A seller offering the minimum desired sales price is determined as a final winning seller, and the final winning seller possesses a right to sell the product corresponding to the total quantity of product ordered by only the purchasers who have presented a purchase maximum price equal to or higher than the winning sale price.

The purchasers who have presented a purchase maximum price lower than the winning sale price when they apply for purchase are automatically dropped out (passed in) from the list of purchasers entitled to make a purchase, through computer processing.

(If purchase amount is prepaid before the contract price is determined (before the purchase is determined), it is possible to automatically refund the prepaid amount to the dropout purchasers.)

Describing in further detail, even in the prepayment method where payment is made before a contract price is determined (before purchase is determined) (mainly, when a purchaser applies for purchase), purchasers who have applied for purchase at a price lower than the contract price are dropped out from the list of purchasers entitled (determined) to make a purchase. Therefore, it is quite natural that penalties (e.g., money, points, or credit) are imposed on the purchasers who cancel the purchase although they have applied for purchase at a purchase maximum price equal to or higher than the contract price and won the bid as a purchaser entitled (determined) to make a purchase.

It is since that although the seller makes a bid by offering a low sale price calculated on a small profit and quick return basis under the assumption that purchasers who win the bid will certainly make a purchaser if the purchasers winning the bid cancel the purchase, the seller's profit could be much less than expected, or the seller can make a loss in some cases.

If prepayment is made in this manner, purchasers who actually make a purchase can receive the product by visiting the web site only once when the purchaser applies for purchase.

Even in the post-payment method where payment is made after a contract price is determined (after purchase is determined), purchasers who have applied for purchase at a price lower than the contract price are automatically dropped out from the list of purchasers entitled (determined) to make a purchase. Therefore, it is quite natural that penalties (e.g., money, points, or credit) are imposed on the purchasers who cancel the purchase although they win the bid as a purchaser entitled (determined) to make a purchase.

The reasons are the same as those described in the method where prepayment is made before a contract price is determined (mainly, when a purchaser applies for purchase).

In this manner, since some of the sellers are dropped out like in a conventional method and some of the purchasers are dropped out as well, it can be said as a bidirectional reverse auction.

In the conventional reverse auction or group purchasing method, there stems out inconvenience or inefficiency in the process of transactions as described below. Even the purchasers dissatisfied with the conditions of the winning bid automatically win (automatically succeed in) the bid as a purchaser entitled (determined) to make a purchase, and if the purchase price is prepaid before the contract price is determined (before the purchase is determined), the prepaid amount is refunded only when the purchasers dissatisfied with the contract price express their intention to cancel the purchase. Or, the seller get nervous on various matters, e.g., vaguely expecting that even the purchasers dissatisfied with the contract price could actually make a purchase, whether a prepayment or a post-payment is adopted.

In the method of the present invention, a reverse auction is cleanly processed without something superfluous by automatically dropping out, while the auction is processed, the purchasers who have presented a purchase maximum price lower than the contract price when they apply for purchase, i.e., the purchasers who could be dissatisfied with the contract price, through computer processing. At a later time, the dropout purchasers or new purchase applicants may have a chance to make a purchase. That is, it is possible to give a chance to make a purchase if they pay as much as the contract price.

Paying as much as the contract price means settling a shortage of the payment or paying again a purchase amount reflecting the contract price if the prepayment is automatically cancelled in the case of prepayment, and paying a purchase amount reflecting the contract price in the case of post-payment.

The method of the present invention can be easily understood by observing the specific examples described below.

It is assumed that the state of purchase and sale application for a specific product is as shown in Table 1.

TABLE 1

| | | | Cumulative | | |
|---|---|---|---|---|---|
| | | | total of | | |
| | Purchase | Purchase | purchase | Seller | |
| | maximum price | quantity | quantity | and | Refund |
| Group (A) | (B) | (C) | (D) | bid (E) | (F) |
| 1 | 52,000 | 1 | 1 | | 2,700 |
| 1 | 51,000 | 4 | 5 | | 1,700 |
| 1 | 50,000 | 5 | 10 | | 700 |
| 1 | 49,900 | 10 | 20 | W | 600 |
| 1 | 49,800 | 20 | 40 | | 500 |
| 1 | 49,700 | 30 | 70 | X | 400 |
| 1 | 49,600 | 40 | 110 | | 300 |
| 1 | 49,500 | 50 | 160 | Y | 200 |
| 1 | 49,400 | 40 | 200 | | 100 |
| 1 | 49,300 | 30 | 230 | Z | 0 |
| 2 | 49,200 | 20 | 250 | | 49,200 |
| 2 | 49,100 | 10 | 260 | | 49,100 |
| 2 | 49,000 | 5 | 265 | | 49,000 |
| 2 | 48,800 | 3 | 268 | | 48,800 |
| 2 | 48,700 | 2 | 270 | | 48,700 |

Column A shows groups of purchase applicants.

Describing the conclusion first, group 1 is a group of successful purchase applicants, and group 2 is a group of dropped purchase applicants.

Column B shows purchase maximum prices of the purchase applicants applied for purchase.

It is assumed that the purchase amount reflecting the purchase maximum price of the purchase applicants applied for purchase is prepaid before the contract price is determined (before the purchase is determined).

Column C shows the quantity of purchase ordered by each purchaser at the purchase maximum price.

For example, the quantity of purchase (quantity of order) applied at the purchase maximum price of 49,300 Korean Won is 30 in total. A plurality of purchase applicants may have applied for purchase at the purchase maximum price of 49,300 Korean Won, and the sum of quantity of purchase applied by the plurality of purchase applicants at the purchase maximum price of 49,300 Korean Won is 30.

Column D shows the cumulative total of Column C.

For example, the cumulative total of the quantity of purchase (quantity of order) applied at a price equal to or higher than the purchase maximum price of 49,300 Korean Won is 230.

Column E shows the bid price of each seller participating in the bid.

Sellers represented as W, X, Y and Z make a bid. Seller W makes a bid at a desired sales price of 49,900 Korean Won for each item, seller X makes a bid at a desired sales price of 49,700 Korean Won for each item, seller Y makes a bid at a desired sales price of 49,500 Korean Won for each item, and seller Z makes a bid at a desired sales price of 49,300 Korean Won for each item.

Then, it is natural that seller Z making a bid at the lowest desired sales price of 49,300 Korean Won wins the bid, and the sale price of each item is determined to be 49,300 Korean Won.

The purchase applicants of group 1 applied for purchase at a purchase maximum price equal to or higher than 49,300 Korean Won become a purchaser entitled (succeeded or determined) to make a purchase. Although they have applied for purchase at purchase maximum prices different from one another, ranging from 49,300 Korean Won to 52,000 Korean Won, they can make a purchase at the same price of 49,300 Korean Won for each item, i.e., the contract price.

Column F shows the state of refund.

The purchase applicants of group 2 applied for purchase at a purchase maximum price lower than 49,300 Korean Won of the contract price are automatically dropped out, and their purchases are automatically cancelled. The amount prepaid by each of the purchase applicants of group 2 is fully refunded.

For the purchase applicants of group 1 applied for purchase at a purchase maximum price equal to or higher than 49,300 Korean Won, an amount is calculated by subtracting [the contract price] from [the unit price calculated by dividing the amount prepaid by each purchase applicant by the quantity of order of each purchase applicant], and an amount calculated by multiplying the calculated amount by the quantity of order of each purchase applicant is refund to each purchase applicant.

For example, if a purchaser orders 3 items at the purchase maximum price of 49,900 Korean Won and prepaid 147,900 Korean Won (=49,900×3), and the contract price is determined to be 49,300 Korean Won, 600 Korean Won (=49,900-49,300) is multiplied by 3, and 1,800 Korean Won is refunded.

The objects and various advantages of the present invention will be further clarified from the preferred embodiments of the present invention practiced by those skilled in the art.

In accordance with an embodiment of the present invention for achieving the above objects, a reverse auction method in an electronic commerce system in which a reverse auction server, a plurality of purchase apply terminals at the purchaser side, and a plurality of sales apply terminals at the seller side communicate with one another through a communication network such as the Internet, includes: a first step of transmitting purchase apply information containing a purchase maximum price and a purchase apply quantity inputted by each purchaser for the same product and storing the purchase apply information in the reverse auction server; a second step of allowing the reverse auction server to provide a connected seller or purchaser with a purchase apply status containing a purchase apply quantity for each purchase maximum price or an accumulated purchase apply quantity for each accumulated purchase maximum price accumulated to the level equal to or higher than each purchase maximum price; a third step of transmitting bidding information containing a desired sales price inputted after review of the purchase apply status by each seller and storing the bidding information in the reverse auction server; a fourth step of enabling the reverse auction server to provide or notify, after the completion of bidding, the result of bidding in which a seller who has made a bid at the lowest desired sales price is determined as a winning bidder, the relevant desired sales price is determined as a contract price, i.e., a sales price, the purchase apply quantities of all purchase maximum prices equal to or higher than the contract price are intensively bid to the winner, and sellers other than the winning bidder are left out of the bidding; and a fifth step of enabling the reverse auction server to provide or notify the result of a deal in which all purchasers who have applied at the purchase maximum price equal to or higher than the contract price are determined as purchasers entitled to make a purchase, all purchasers who have applied with the purchase maximum price lower than the contract price are left out, and the contract price is contained.

Preferably, the reverse auction method may further include: a step 1-1 of allowing each purchaser to prepay all or a part of a purchase amount while applying for purchase; and a step 5-1 of allowing the reverse auction server to refund the entire purchase amount prepaid by the dropout purchasers and to refund, among the purchase amount prepaid by the purchaser determined to make a purchase, an amount more than a difference prepaid in excess of the purchase amount according to the contract price.

Preferably, the reverse auction method may further include: a step 5-2 of allowing the reverse auction server to collect all or a part of the purchase amount prepaid by a purchaser who cancels the purchase apply after the bidding started by the seller, among the purchasers who have applied for purchase, as a penalty for purchase cancellation, and to refund an amount remaining after the penalty is collected.

Preferably, the reverse auction method may further include: a step 3-1 of allowing each seller to prepay a bid bond while participating in the bidding; a step 4-1 of allowing the reverse auction server to refund the bid bond prepaid by the dropout sellers; and a step 4-2 allowing the reverse auction server to collect the prepaid bid bond when the winning seller cancels selling or does not faithfully fulfill duties accompanied by a right to sell granted to the seller.

### BRIEF DESCRIPTION OF THE DRAWINGS

FIG. 1 is a block diagram showing an electronic commerce system for a reverse auction method according to a preferred embodiment of the present invention.

FIG. 2 is a flowchart illustrating a reverse auction method according to a preferred embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like part throughout the various figures and embodiments of the present invention. The drawings are not necessarily to scale and in some instance, illustrate features of the embodiments.

Some of terminologies used in the reverse auction method according to the present invention are defined.

Product: Goods or services that are targets of trade.

Purchase apply information: Information inputted by each purchaser when the purchaser applies for purchase and provided to the reverse auction server 16, which may include a purchase target product, a purchase maximum price, a purchase apply quantity, personal information on the purchaser, information for refund, and the like.

Bidding information: Information inputted by each seller when the seller makes a bid, which may include a sales target product, a desired sales price, personal information on the seller, information for refund, and the like.

Purchase maximum price: A price presented when a purchaser applies for purchase as a maximum amount that the purchaser can pay for a purchase target product, which is an amount expressing an intention to fulfill the purchase if a sales price is determined to be equal to or lower than the price.

Desired sales price: A price offered when a seller makes a bid as a minimum price at which the seller can sell a sales target product.

Contract price: The minimum price among the desired sales prices offered by a plurality of sellers who make a bid, i.e., a sales price determined when the bidding is concluded.

Exemplary embodiments of the present invention will be described below in more detail with reference to the accompanying drawings.

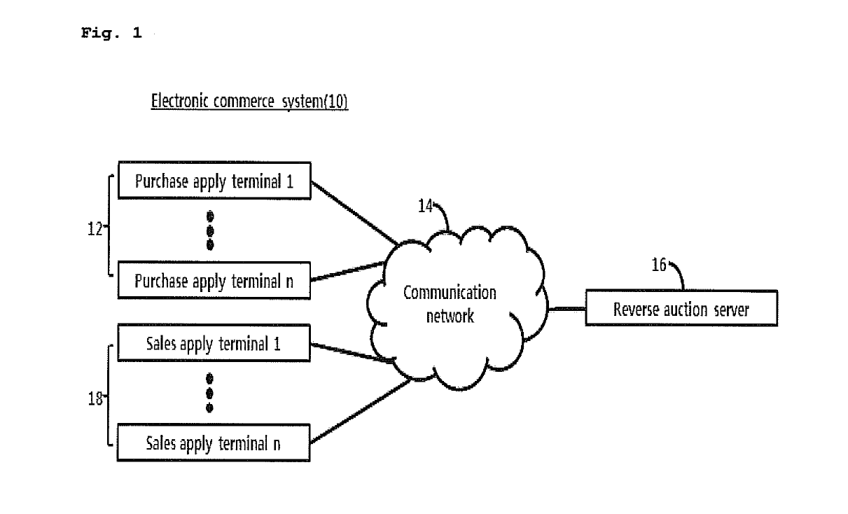

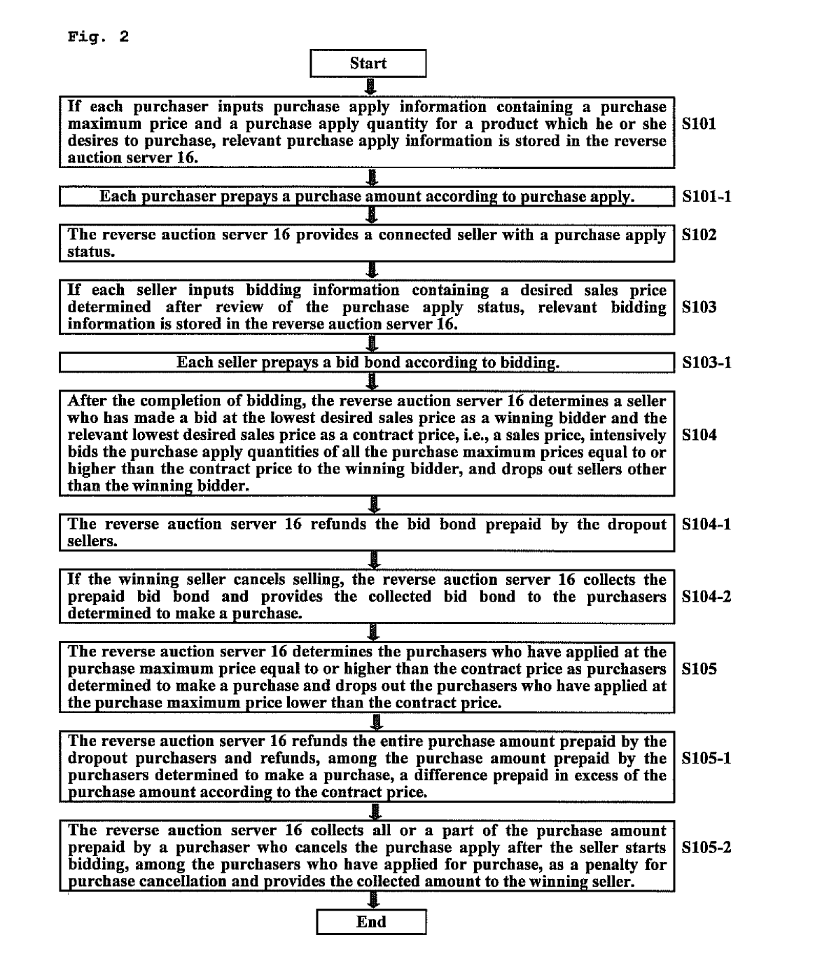

FIG. 1 is a block diagram showing an electronic commerce system for a reverse auction method according to a preferred embodiment of the present invention, and FIG. 2 is a flowchart illustrating a reverse auction method according to a preferred embodiment of the present invention.

The electronic commerce system 10 for implementing the reverse auction method according to the present invention comprises a plurality of purchase apply terminals 12 for applying for purchase by a plurality of unspecific purchasers, a plurality of sales apply terminals 18 for making a bid by a plurality of unspecific sellers, a reverse auction server 16 for operating an online site where the reverse auction is performed, and a communication network 14 including the Internet for communications.

The purchase apply terminal 12 is a client terminal used by a purchaser to connect to the reverse auction server 16, confirm information on the proceeding of a reverse auction, and input purchase apply information of the purchaser if the purchaser wants to purchase a specific desired product through a reverse auction.

The sale apply terminal 18 is a client terminal used by a seller to connect to the reverse auction server 16, confirm information on the proceeding of a reverse auction, input purchase apply information of the seller when the seller wants to make a bid in a specific reverse auction.

The reverse auction server 16 is used to operate an electronic commerce site in a reverse auction method, which provides information on the proceeding of a currently performed reverse auction, receives and stores purchase apply information from the purchase apply terminal 12, receives and stores bidding information from the sale apply terminal 18, and processes a reverse auction execution process.

Since the reverse auction method according to the present invention includes a process of receiving a prepayment from purchasers or sellers and refunding the prepayment performed by the reverse auction server 16, the reverse auction server 16 can be implemented to be connected to a separate payment server (not shown) or perform a payment function of its own. In addition, the reverse auction server 16 can be connected to a separate sales server (not shown) in order to provide information on sale products.

The electronic commerce system 10 is quite similar to an electronic commerce system for conventional general Internet shopping malls and Internet (or reverse auction) sites. Since the present invention is different from conventional ones only in the method of operating reverse auctions, only operating programs provided in the reverse auction server 16 need to be changed. Although the system is not described in detail, those skilled in the art may easily implement the present invention within the scope of a general electronic commerce system constructing techniques.

The reverse auction method according to the present invention is a reverse auction system of electronic commerce in which a reverse auction is performed for the same product at the same proceeding time with the present of sellers and purchasers. If a purchaser applies for purchase by inputting purchase apply information containing a purchase maximum price corresponding to the maximum price that the purchaser can pay for the purchase target product and a purchase apply quantity corresponding to the number of products desired to purchase within a purchase apply time period, each seller reviews the purchase apply status of the purchaser and makes a bid by inputting bidding information including a lowest desired sales price that the seller can accept within a bid time period that follows (or overlaps with) the purchase apply time period. The reverse auction server 16 determines the lowest desired sales price among the desired sales prices offered by a plurality of sellers as a contract price, i.e., sale price, determines a seller who has made a bid at the corresponding desired sales price as a winning bidder, grants a right to sell the cumulative quantity of all purchase maximum prices corresponding to the contract price or higher to the winning bidder, immediately cancels the purchase apply of the purchasers who have applied at a purchase maximum price lower than the contract price, and immediately cancels the bids of the sellers who have failed in the bid.

Accordingly, some sellers are naturally dropped out as is in the conventional reverse auction method, and some of the purchasers will be dropped out as well unlike the conventional reverse auction method.

A purchaser may guarantee his or her purchase apply by prepaying all or a part of a purchase amount when the purchaser applies for purchase by inputting purchase apply information including his or her purchase maximum price and purchase apply quantity. The reverse auction server 16 collects all or a part of the purchase amount prepaid by a purchaser who cancels the purchase apply after bidding is started among the sellers or purchasers entitled to make a purchase are determined, and pays the collected amount to the sellers, and thus losses of the sellers incurred by purchasers' cancellation of purchase can be compensated.

Since all the purchasers who have applied for purchase can be secured to fulfill the purchase without fail, the sellers can correctly grasp the quantity of product that can be sold through the reverse auction in advance and make a bid at a reasonable real lowest price based on the quantity of corresponding products to be sold.

The reverse auction server 16 immediately refunds the prepaid amount if the purchasers prepaid the purchase amount are not determined as a purchaser entitled (succeeded) to make a purchase and dropped out depending on the result of the reverse auction. If the prepaid purchasers are determined as a purchaser entitled to make a purchase, the reverse auction server 16 substitutes the prepaid amount for the cost of purchased products, and refunds the difference prepaid in excess of the purchase amount according to the contract price.

In addition, the sellers prepay a certain amount of bid bond when they make in a bid, and if a winning seller cancels the bid or does not faithfully deliver the products to the purchasers after winning the bid, the reverse auction server 16 collects and provides the prepaid bid bond to the purchasers entitled to make a purchase, and thus losses of purchasers incurred by seller's cancellation of sales can be compensated and credibility of trade can be secured.

According to the present invention, the reverse auction server 16 closes a deal not using the purchase maximum price offered by each purchaser, but using the lowest price among the desired sales prices offered by the sellers, so that all the purchasers determined as a purchaser entitled to make a purchase can purchase the product at the same lowest price, and thus a plurality of purchasers can be satisfied by performing one reverse auction.

In relation to this, the reverse auction server 16 may basically receive a prepayment of purchase amount calculated considering the purchase maximum price and the purchase apply quantity inputted by each purchaser. Therefore, the reverse auction server 16 calculates a difference between the purchase amount prepaid by each purchaser and the purchase amount determined based on the contract price for each purchaser and refunds the calculated amount.

Furthermore, the sellers confirm the purchase apply status collected and provided by the reverse auction server 16 at the point of making a bid and make a bid for the cumulative quantity of product accumulated to an appropriate price level. If a seller wins the bid, the seller can sell a large quantity of products at a time. Therefore, the sellers compete very ardently, and thus the sale price can be lowered to the maximum.

Of course, since even the purchasers can be dropped out if they apply for purchase at a purchase maximum price that is exorbitantly low, the purchasers will apply for purchase at an appropriate purchase maximum price in order not to be dropped out, and thus the quantity of product determined to be purchased will be increased greatly.

The reverse auction method according to the present invention comprises the steps described below.

1) A first step S101 of transmitting purchase apply information containing a purchase maximum price and a purchase apply quantity inputted by each purchaser for the same product and storing the purchase apply information in the reverse auction server 16.

—In this step, each purchaser connects to the reverse auction server 16 using the purchase apply terminal 12, confirms information on the proceeding of a reverse auction for the sale products provided by the reverse auction server 16, and input purchase apply information containing a desired purchase maximum price and purchase apply quantity if the purchaser wants to select and purchase a specific product through a reverse auction, and then the purchase apply information is transmitted and stored in the reverse auction server 16.

At this point, each purchaser may input a desired purchase maximum price directly or select a desired purchase maximum price from a list provided by the inverse auction server 16.

Accordingly, since a plurality of purchasers inputs a purchase maximum price, a plurality of purchase maximum prices can be created.

2) A second step S102 of allowing the reverse auction server to provide a connected seller or purchaser with a purchase apply status containing a purchase apply quantity for each purchase maximum price or an accumulated purchase apply quantity for each accumulated purchase maximum price accumulated to the level equal to or higher than each purchase maximum price.

—In this stepp, the reverse auction server 16 provides the purchase apply status containing a purchase apply quantity for each purchase maximum price or an accumulated purchase apply quantity for each accumulated purchase maximum price accumulated to the level equal to or higher than each purchase maximum price in response to the request of the seller or purchaser.

Here, the cumulative purchase apply quantity for each purchase maximum price is the sum of purchase apply quantity of a product applied to be purchased at a price equal to or higher than the purchase maximum price.

For example, the reverse auction server 16 may provide the purchase apply status as shown in table 2.

TABLE 2

| Purchase | | Cumulative | |
|---|---|---|---|
| maximum price | Purchase apply | purchase apply | Expected total sales |
| (a) | quantity (b) | quantity (c) | amount (a × c) |
| 220,000 Won | 10 | 10 | 2,200,000 Won |
| 210,000 Won | 30 | 40 | 8,400,000 Won |
| 200,000 Won | 50 | 90 | 18,000,000 Won |
| 190,000 Won | 40 | 130 | 24,700,000 Won |
| 180,000 Won | 20 | 150 | 2,7000,000 Won |
| 170,000 Won | 10 | 160 | 27,200,000 Won |
| 160,000 Won | 5 | 165 | 26,400,000 Won |

Accordingly, the sellers may confirm the purchase apply status provided as shown above, determine a desired sales price that he or she can offer, and make a bid.

3) A third step S103 of transmitting bidding information containing a desired sales price inputted after review of the purchase apply status by each seller and storing the bidding information in the reverse auction server 16.

—In this step, each seller reviews the purchase apply status provided by the reverse auction server 16, determines his or her desired sales price, and participates in a bid.

For example, referring to Table 2, a seller determines his or her desired sales price referring to the purchase apply status such as an accumulated purchase apply quantity and an expected total sales amount of each purchase maximum price and participates in a bid within a bid time period.

As an example, if an expected total sales amount is 27,200,000 Won and its cumulative quantity of the product is 160, the unit price of the product is 170,000 Won. If a seller determines that it reasonable to sell total quantity of 160 at the unit price, the seller participates in the bidding at a price close to the unit price.

Of course, since the seller can sell a fairly large quantity of products at a time, the seller will determine a desired sales price by calculating a profit on a small profit and quick return basis and make a bid with the price.

The desired sales price for making a bid may be one of the existing purchase maximum prices or a unique price of the seller.

4) A fourth step S104 of allowing the reverse auction server 16 to provide or notify, after the completion of bidding, the result of bidding in which a seller who has made a bid at the lowest desired sales price is determined as a winning bidder, the relevant desired sales price is determined as a contract price, i.e., a sales price, the purchase apply quantities of all purchase maximum prices equal to or higher than the contract price are intensively bid to the winner, and sellers other than the winning bidder are left out of the bidding;

—In this step, as the bidding is closed, the reverse auction server 16 selects a seller making a bid at the lowest desired sales price, determines the selected seller as a winning bidder, determines the relevant desired sales price as a contract price, i.e., a sales price, and drops out sellers other than the winning bidder. The reverse auction server 16 intensively bids the purchase apply quantities of all the purchase maximum prices equal to or higher than the contract price to the winning bidder, and grants a right to sell a large quantity of products.

Like this, in the reverse auction method according to the present invention, since all the quantities of the product applied to make a purchase at all the purchase maximum prices equal to or higher than the contract price are intensively bid to the winning bidder, a seller can win the bid and sell a large quantity of products. Therefore, since the seller can sufficiently lower the desired sales price by calculating a profit on a small profit and quick return basis, purchasers can reap the profit ultimately, and a sufficient profit can be naturally generated for a corresponding seller.

Furthermore, since a right to sell a large quantity of products at a time is granted, sellers will fiercely compete with one another, and a real lowest price that has never been experienced before in electronic commerce can be provided accordingly.

In addition, a bid time period in which sellers can make a bid may start at the same time as or later than a purchase apply time period in which purchasers can apply for purchase, and the bid time period may end at the same time as or later than the end of the purchase apply time period.

5) A fifth step S105 of allowing the reverse auction server 16 to provide or notify the result of a deal in which all purchasers who have applied at the purchase maximum price equal to or higher than the contract price are determined as purchasers entitled to make a purchase, all purchasers who have applied with the purchase maximum price lower than the contract price are left out of the bidding, and the contract price is contained.

—In this step, the reverse auction server 16 determines all the purchasers who have applied at a purchase maximum price corresponding to the contract price or higher as purchasers entitled to make a purchase and drops out all the purchasers who have applied at a purchase maximum price lower than the contract price.

According to the present invention, since not a purchase maximum price at which a purchaser applies for purchase, but the contract price is determined as a sales price, all the purchasers who have made a contract based on the sale price can purchase the product at the same price, and thus all the participant will be satisfied.

In addition, the reverse auction method according to the present invention may further comprise the steps described below.

1-1) Step 1-1 S101-1 of allowing each purchaser to prepay all or a part of a purchase amount while applying for purchase.

—In this step, each purchaser guarantees his or her purchase apply by prepaying all or a part of a purchase amount based on the purchase maximum price and the purchase apply quantity of the product that he or she applies for when the purchaser applies for purchase.

If the purchaser does not prepay the purchase amount, the seller may cancel the purchase apply later without any restriction, and the seller can make a loss. Therefore, a prepayment is received in order to collect a part of the prepaid amount when the purchaser cancels the purchase apply at a later time.

5-1) Step 5-1 S105-1 of allowing the reverse auction server 16 to refund the entire purchase amount prepaid by the dropout purchasers and to refund, among the purchase amount prepaid by the purchaser determined to make a purchase, an amount more than a difference prepaid in excess of the purchase amount according to the contract price.

—In this step, the reverse auction server 16 refunds the entire purchase amount prepaid by the dropout purchasers, as well as an amount prepaid in excess of the purchase amount according to the contract price, among the purchase amount prepaid by the purchaser determined to make a purchase, after the reverse auction is over.

That is, since the contract price is determined as a final sale price, an amount calculated by subtracting the purchase amount according to the final bid amount from the amount initially calculated and prepaid based on his or her purchase maximum price is refunded.

Although it is almost impossible, an amount of more than the difference may be refunded.

Since the present invention is applied not for the patent of a method for refunding a part of an amount paid on a credit card, this problem is not considered to be solved in the present invention. However, refunding an amount prepaid on a credit card, that is, a few methods for refunding an amount calculated by subtracting a purchase amount according to the contract price from a prepaid amount to a purchaser who prepaid an amount exceeding the purchase amount according to the contract price using a credit card, is described below. (there may be other methods)

1. Prepayment cancellation and payment of a new purchase amount according to a contract price are automated.

2. It is processed such that a purchaser who prepaid an amount exceeding a purchase amount according to the contract price immediately deposits an amount as much as subtracting the purchase amount according to the contract price from the prepaid amount in cash on the spot, and a credit card is used only to leave a credit card usage history in order to reap the benefit of the credit card, such as mileage, points, or the like. Then, a plus amount (a prepaid amount) and a minus amount (an amount as much as subtracting a purchase amount according to the contract price from the prepaid amount) are requested to settle the purchase amount according to the contract price as a result.

3. A credit card company deposits the requested amount into a customer's account.

4. The winning seller deposits an amount as much as subtracting a purchase amount according to the contract price from the prepaid amount into a customer's account (the seller accepts a loss of card fee).

5. Cash points are accumulated as much as an amount calculated by subtracting a purchase amount according to the contract price from the amount prepaid to a credit card company (A point system is newly established, in which points can be turned into cash at any time).

6. Cash points or cyber money is accumulated as much as an amount calculated by subtracting a purchase amount according to the contract price from the amount prepaid to a reverse auction site (A point system is newly established, in which points can be turned into cash at any time, or the amount is accumulated as cyber money).

Step 5-2 S105-2 of allowing the reverse auction server to collect all or a part of the purchase amount prepaid by a purchaser who cancels the purchase apply after the bidding started by the seller, among the purchasers who have applied for purchase, as a penalty for purchase cancellation, and to refund an amount remaining after the penalty is collected.

—In this step, if a seller can make a loss since a purchaser, among the purchasers who have applied for purchase, cancels the purchase apply after bidding is started among the sellers or the purchaser is determined as a purchaser entitled to make a purchase, all or a part of the purchase amount prepaid by the purchaser is collected as a penalty and provided to the seller, and thus losses of the seller are compensated and credibility of trade is secured.

That is, sellers make a bid at a lowest sale price possible by calculating a profit on a small profit and quick return basis under the assumption that all the purchasers who have applied for purchase will certainly make a purchase if they are determined as a purchaser entitled to make a purchase. However, if the purchasers cancel the purchase apply, the seller's profit could be much less than expected, or the seller can make a loss instead in some cases, and thus certain penalties are imposed on the purchasers canceling the purchase apply.

Furthermore, the reverse auction method according to the present invention may further comprise the steps described below.

3-1) Step 3-1 S103-1 of allowing each seller to prepay a bid bond while participating in the bidding.

—In this step, sellers participating in the bid prepay a bid bond in order to compensate losses of purchasers determined to make a purchase that can be incurred when the winning seller cancels the bid or does not faithfully deliver the products. If the winning seller does not fulfill his or her duties at a later time, the prepaid bid bond is provided to the winning purchasers, and thus credibility of trade can be secured.

4-1) Step 4-1 S104-1 of allowing the reverse auction server 16 to refund the bid bond prepaid by the dropout sellers; and

In this step, the bid bond prepaid by the dropout sellers is naturally refunded.

4-2) Step 4-2 S104-2 of allowing the reverse auction server 16 to collect the prepaid bid bond when the winning seller cancels selling or does not faithfully fulfill duties accompanied by a right to sell granted to the seller.

—In this step, the bid bond prepaid by the seller is collected in order to compensate losses of purchasers determined to make a purchase when the winning seller cancels selling or does not faithfully provide the products.

On the other hand, there may be a plurality of winning bidders participating in the bidding on the same bid conditions, and competition may arise among them. When the competition arises, a final winning bidder can be determined based on predetermined agreements.

For example, the right to sell can be granted to a bidder who makes a bid in the first place, or it is possible to systematically restrict a bidder not to make a bid at a desired sales price that is the same as any one of previously offered desired sales prices.

In addition, two more steps described below can be added.

The step of allowing the reverse auction server to give a chance for purchasing the product at the contract price to new purchase applicants or the dropout purchasers who have applied for purchase at a purchase maximum price lower than the contract price after the contract price is determined by allowing the new purchase applicants or the dropout purchasers to completely pay a total purchase amount including the whole purchase amount or shortage of the purchase amount for a purchase amount reflecting the contract price.

—In this step, new purchase applicants or the dropout purchasers who have applied for purchase at a purchase maximum price lower than the contract price may have a chance for purchasing the product at the contract price.

(If another chance is given, there needs one more step in which the dropout purchasers additionally pay shortage of the purchase amount. In this step, if an amount prepaid by a purchaser is smaller than an amount calculated by multiplying the contract price by the purchase quantity of the product ordered by the purchaser determined as a purchaser entitled to make a purchase, the purchaser should pay an amount subtracting the amount prepaid by the purchaser from the amount calculated by multiplying the contract price by the purchase quantity of the product ordered by the purchaser determined as a purchaser entitled to make a purchase.

Alternatively, if the prepayment is automatically canceled, the total purchase amount according to the contract price may be paid again.

A new purchaser only needs to pay the purchase amount according to the contract price.)

Alternatively, when the purchase apply information is inputted, this step may be selected to be automatically performed.

Here, automatically performing the step includes automatic payment of a shortage amount.)

The step of providing an information exchange means including a note or a comment for exchanging information on an appropriate contract price among the purchasers or sellers.

—In this step, information exchange including estimation and discussion about a reasonable contract price is allowed through a means including comments, notes, and bulletin boards for facilitating communications among sellers and purchasers.

Its purpose is to allow acquisition of sufficient information on the estimation of an appropriate final sale price. Therefore, it is to minimize the number of purchasers who fail to purchase the product as a result of applying for purchase at a purchase maximum price that is exorbitantly low due to the lack of information, among the purchasers who have intended to purchase the product certainly if the price is reasonable. As a result, the quantity of product traded is increased, and desired final sale prices offered by the sellers will be lowered as much as increase of the quantity of product that can be contracted. Therefore, since the final sale price is lowered, purchasers also can make a profit.

Of course, since the quantity of contracted product can be increased, it is also advantageous to the sellers.

For example, quantity of product traded can be increased by persuading the purchasers applied at a price lower than a desired sales price that will be offered by each seller to re-apply at a price corresponding to the desired sales price or more. It also prevents purchasers from applying for purchase at an extremely low price due to the lack of information so that the purchasers may not to lose a chance for purchasing the product.

According to the present invention, since a plurality of purchasers can make a purchase at the same lowest price by performing one reverse auction, all the purchasers are satisfied, and sellers are allowed to sell a large quantity of products on a small profit and quick return basis. Accordingly, it is possible to achieve the effect of generating the best profit for both purchasers and sellers.

Describing in further detail, each purchaser can present a maximum amount that can be paid for a product to be purchased (there may be a plurality of purchase maximum prices), and a purchaser applied for purchase on a condition of purchase (especially, purchase price) that does not correspond to winning conditions (especially, price) is once dropped out from the list of purchasers who can make a purchase (who is determined to make a purchase). Therefore, a reverse auction satisfying all (100%) the different purchase conditions of a plurality of purchasers, not the purchase condition of only one purchaser, can be accomplished through a reverse auction performed just once, and all the quantities of the product applied to be purchased at a purchase maximum price equal to or higher than the winning sale price are intensively bid to a seller offering the winning sale price. Therefore, sellers compete with one another more fiercely, and the winning sale price can be lower than the minimum price that can be found through general price comparison at Internet shopping malls.

Particularly, the effects described below will be further remarkable if a reverse auction adopts prepayment where payment is made before a contract price is determined (before purchasers entitled to make a purchase are determined). From the viewpoint of a seller having a small capital, the seller may provide a product supplier (e.g., manufacturing company) with an evidence proving that a prepaid contract for a large quantity of products is made with the seller having a small capital at a reverse auction according to the present invention. Even a seller having a small capital can order a large quantity of products from a supplier (e.g., manufacturing company) (on credit) like a seller having a large capital, although it does not have sufficient funds. Therefore, since the supplier (e.g., manufacturing company) can lower the unit price of the product further more, the seller can make a bid at a further lower desired sales price. As a result, a sales price determined by a successful bid can be lowered further more.

Furthermore, even a seller that does not have a capital at all may offer a sales price that can be offered by a seller having a large capital.

As a result, sellers compete with one another more fiercely, and it is possible to purchase the product at a real minimum price.

If the reverse auction according to the present invention is actively used, a seller may offer a fake sale price at general Internet shopping malls in order to offer a real lowest price at a site performing the reverse auction according to the present invention. It is expected that the effect of the present invention is as high as to suspect the lowest price at general shopping malls to be a fake in many cases.

While the present invention has been described with respect to the specific embodiments, it will be apparent to those skilled in the art that various changes and modifications may be made without departing from the spirit and scope of the invention as defined in the following claims.

1. A reverse auction method in an electronic commerce system in which a reverse auction server, a plurality of purchase apply terminals at the purchaser side, and a plurality of sales apply terminals at the seller side communicate with one another through a communication network such as the Internet, the method comprising:
a first step of transmitting purchase apply information containing a purchase maximum price and a purchase apply quantity inputted by each purchaser for the same product and storing the purchase apply information in the reverse auction server;
a second step of allowing the reverse auction server to provide a connected seller or purchaser with a purchase apply status containing a purchase apply quantity for each purchase maximum price or an accumulated purchase apply quantity for each accumulated purchase maximum price accumulated to the level equal to or higher than each purchase maximum price;
a third step of transmitting bidding information containing a desired sales price inputted after review of the purchase apply status by each seller and storing the bidding information in the reverse auction server;
a fourth step of allowing the reverse auction server to provide or notify, after the completion of bidding, the result of bidding in which a seller who has made a bid at the lowest desired sales price is determined as a winning bidder, the relevant desired sales price is determined as a contract price, i.e., a sales price, the purchase apply quantities of all purchase maximum prices equal to or higher than the contract price are intensively bid to the winner, and sellers other than the winning bidder are left out of the bidding; and
a fifth step of allowing the reverse auction server to provide or notify the result of a deal in which all purchasers who have applied at the purchase maximum price equal to or higher than the contract price are determined as purchasers entitled to make a purchase, all purchasers who have applied with the purchase maximum price lower than the contract price are left out of the bidding, and the contract price is contained.

2. The method of claim 1, further comprising:
a step 1-1 of allowing each purchaser to prepay all or a part of a purchase amount while applying for purchase; and
a step 5-1 of allowing the reverse auction server to refund the entire purchase amount prepaid by the dropout purchasers and to refund, among the purchase amount prepaid by the purchaser determined to make a purchase, an amount more than a difference prepaid in excess of the purchase amount according to the contract price.

3. The method of claim 2, further comprising:
a step 5-2 of allowing the reverse auction server to collect all or a part of the purchase amount prepaid by a purchaser who cancels the purchase apply after the bidding started by the seller, among the purchasers who have applied for purchase, as a penalty for purchase cancellation, and to refund an amount remaining after the penalty is collected.

4. The method of claim 1, further comprising:
a step 3-1 of allowing each seller to prepay a bid bond while participating in the bidding;
a step 4-1 of allowing the reverse auction server to refund the bid bond prepaid by the dropout sellers; and
a step 4-2 allowing the reverse auction server to collect the prepaid bid bond when the winning seller cancels selling or does not faithfully fulfill duties accompanied by a right to sell granted to the seller.

5. The method of claim 1, further comprising the step of: allowing the reverse auction server to give a chance for purchasing the product at the contract price to new purchase applicants or the dropout purchasers who have applied for purchase at a purchase maximum price lower than the contract price after the contract price is determined by allowing the new purchase applicants or the dropout purchasers to completely pay a total purchase amount including the whole purchase amount or shortage of the purchase amount for a purchase amount reflecting the contract price.

6. The method of claim 1, further comprising the step of providing an information exchange means including a note or a comment for exchanging information on an appropriate contract price among the purchasers or sellers.
